(19) United States
(12) Patent Application Publication
(10) Pub. No.: US 2013/0337785 A1
(43) Pub. Date: Dec. 19, 2013

(54) METHODS AND SYSTEMS FOR PROVIDING A DYNAMIC ARRAY OF SERVICES AND INFORMATION THROUGH A DYNAMIC ICON

(71) Applicant: Airpush, Inc., (US)

(72) Inventor: Asher Delug, Los Angeles, CA (US)

(73) Assignee: Airpush, Inc., Los Angeles, CA (US)

(21) Appl. No.: 13/829,999

(22) Filed: Mar. 14, 2013

Related U.S. Application Data
(63) Continuation-in-part of application No. 13/623,844, filed on Sep. 20, 2012.
(60) Provisional application No. 61/654,703, filed on Jun. 1, 2012.
(60) Provisional application No. 61/654,802, filed on Jun. 1, 2012.
(60) Provisional application No. 61/672,939, filed on Jul. 18, 2012.
(60) Provisional application No. 61/698,449, filed on Sep. 7, 2012.

(51) Int. Cl. H04W 4/00

(52) U.S. Cl. CPC H04W 4/003
USPC 455/414.1

(57) ABSTRACT

Among other disclosed subject matter, a computer-implemented method for providing a plurality of applications through a dynamic icon is disclosed. The method includes receiving request to invoke a first app in a smart device, the first app invoked by activation of a corresponding first app icon displayed at the smart device. The method further includes selecting one of a plurality of database apps to be offered at the smart device in response to the received request. The selected one of the plurality of database apps is offered as the first app in the smart device in response to the request to invoke the first app, where a particular one of the plurality of database apps is dynamically selected in response to the request based on one or more criteria associated with the selection of the one of the plurality of database apps and the selected one of the plurality of database apps is offered as the first app at the smart device.

### CLAIM OF PRIORITY

This application is a continuation-in-part of U.S. Nonprovisional application Ser. No. 13/623,844 filed Sep. 20, 2012, which claims priority to U.S. Provisional Application No. 61/654,703, filed Jun. 1, 2012, 61/654,802 filed Jun. 1, 2012, 61/672,939, filed Jul. 18, 2012, 61/698,449, filed Sep. 7, 2012, 61/713, 421, filed Oct. 12, 2012, 61/760,952, filed Feb. 5, 2013, all of which are hereby incorporated by reference in their entireties.

### FIELD

The present invention generally relates to providing services and information to a smart device user. More particularly, the present invention relates to methods and systems for providing a dynamic array of services and information to a smart device user through a dynamic icon installed on the smart device.

### BACKGROUND

Smartphones have become increasingly popular in recent years. Smartphones not only have the capabilities of making calls but also allow applications to be installed and executed. Examples of such smartphones include Apple's iPhone as well as models from Nokia and Motorola, and other similar smartphone devices. Smartphone have been developed with a number of operating systems (OS), including Windows based smartphones and Android based smartphones. As the popularity of such phones increases, the number of smartphone applications available has increased as well. Applications available for smartphones include games, utilities like calendars, business applications, applications that render certain web sites in a particular way on a given smartphone, e.g., the Facebook and NYTimes applications for iPhone. Once an application has been installed on a smartphone, a user of the smartphone may launch the installed application by selecting an icon representing the application on the smartphone's display screen. The icon could be an image associated with the application, where every time the user selects the icon image, the same associated application is launched.

### SUMMARY OF THE DESCRIPTION

The present invention relates to enabling the user launch an array of applications and services in a smartphone through a dynamic icon, where applications or services previously associated with the dynamic icon can be disassociated and new applications or services associated with the dynamic icon.

In a first aspect, a computer-implemented method for providing a plurality of applications through a dynamic icon is disclosed. The method includes receiving request to invoke a first app in a smart device, the first app invoked by activation of a corresponding first app icon displayed at the smart device. The method further includes selecting one of a plurality of database apps to be offered at the smart device in response to the received request. The selected one of the plurality of database apps is offered as the first app in the smart device in response to the request to invoke the first app, where a particular one of the plurality of database apps is dynamically selected in response to the request based on one or more criteria associated with the selection of the one of the plurality of database apps and the selected one of the plurality of database apps is offered as the first app at the smart device.

Implementations can include any, all or none of the following features. The method can further include determining a time-of-the-day value associated with the received request. The method can also include selecting one of the plurality of database apps as the first app based on the determined time-of-the-day value. The method further includes, prior to receiving the request, obtaining a first user's preference relating to a type of app to offer based on different time-of-the-day values. The method includes, in response to receiving the request from the first user, selecting a given one of the plurality of database apps according to the previously obtained preferences of the first user. The method can further include receiving the request from the first user at a first time-of-the-day value. The method can also include determining the given app from one of a first subplurality of apps from the plurality of database apps, the first subplurality of apps corresponding to the first user's preferences for apps to be offered for the first time-of-the-day value.

The method can further include determining a first user associated with the smart device. The method can also include selecting a given one of the plurality of apps as the first app based on the determined first user. When determining the first user associated with the smart device, the method can further include receiving an image of the first user from the smart device and identifying the first user using one or more image recognition methodologies. When determining the user associated with the smart device, the method can further include receiving identity information as input from the first user in conjunction with receiving the request. When determining the user associated with the smart device, the method can further include identifying the first user based on a current user account used in conjunction with the received request.

The method can further include prior to receiving the request, obtaining the first user's preference relating to a type of app to offer based on the user's identity. The method can also include, in response to receiving the request from the first user, selecting a given one of the plurality of database apps according to the previously obtained preferences of the first user. When obtaining the first user's preference, the method can further include obtaining the first user's preference relating to a type of app to offer based on a time-of-day value associated with the received request. The method can further include determining a usage-level of a first user associated with the received request. The method can also include selecting one of the plurality of database apps as the first app based on the determined usage-level.

The method can also include, where the usage-level is one or more of: (1) an age-level associated with the first user; (2) a maturity-level associated with the first user; or (3) a skill-level associated with the first user. The method can further include, where the plurality of database apps corresponds to a given app with a plurality of level settings, each database app corresponding to the given app with a different level setting, each level setting associated with a given skill-level required for engagement with a corresponding database app. The method can further include, wherein the plurality of database apps corresponds to a given app with a plurality of level settings, each database app corresponding to the given app with a different level setting, each level setting associated with a given maturity-level required for engagement with a corresponding database app.

In a second aspect, a computer-implemented method for providing a plurality of applications through a dynamic icon is disclosed. The method includes receiving a request from a first user to invoke a first app in a smart device, the first app invoked by activation of a corresponding first app icon displayed at the smart device. The method includes determining an identity associated with the first user. The method includes selecting one of a plurality of database apps to be offered at the smart device in response to the received request. Where the selected one of the plurality of database apps is offered as the first app in the smart device in response to the request to invoke the first app, the method further includes a particular one of the plurality of database apps dynamically selected in response to the request based on one or more criteria associated with the selection of the one of the plurality of database apps and the selected one of the plurality of database apps is offered as the first app at the smart device.

Implementations can include any, all or none of the following features. The method can further include determining a usage-level of the first user and selecting one of the plurality of database apps as the first app based on the determined usage-level. The method can further include, wherein the usage-level is one or more of (1) an age-level associated with the first user; (2) a maturity-level associated with the first user; or (3) a skill-level associated with the first user. When determining the identity of the first user, the method further includes receiving an image of the first user from the smart device and identifying the first user using one or more image recognition methodologies.

The method can further include, wherein determining the identity of the first user includes receiving identity information as input from the first user in conjunction with receiving the request. The method further includes, wherein determining the identity of the first user includes identifying the first user based on a current user account used in conjunction with the received request. The method can further include, prior to receiving the request, obtaining the first user's preference relating to a type of app to offer based on the user's identity. The method can further include, in response to receiving the request from the first user, selecting a given one of the plurality of database apps according to the previously obtained preferences of the first user. The method can further include, wherein obtaining the first user's preference further includes obtaining the first user's preference relating to a type of app to offer based on a time-of-day value associated with the received request.

Implementations can include any, all or none of the following features. Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIG. 2 illustrates a smart mobile phone;

FIG. 3A, which includes FIGS. 3A-1 and 3A-2, illustrates a scenario where, when the time of the day is characterized as “morning”, the content-publisher server provides the mobile user with news reports through the dynamic icon;

FIG. 3B, which includes FIGS. 3B-1 and 3B-2, illustrates a scenario where, when the time of the day is characterized as “mid-afternoon”, the content-publisher server provides the mobile user with calendar items through the dynamic icon;

FIG. 3C, which includes FIGS. 3C-1 and 3C-2, illustrates a scenario where, when the time of the day is characterized as “night”, the content-publisher server provides the mobile user with a streaming music app through the dynamic icon;

FIG. 4A, which includes FIGS. 4A-1 and 4A-2, illustrates a scenario where, when the publisher associated with the dynamic icon is determining the content and the publisher specializes in providing word games, the mobile user could be served with various games at a refresh rate determined by either the mobile user or the publisher;

FIG. 4B, which includes FIGS. 4B-1 and 4B-2, illustrates a scenario where, when the mobile user selects the dynamic icon on day 2, the mobile user is provided a new word game called “Scrabble” instead of the previous word game “Boggle”;

FIG. 4C, which includes FIGS. 4C-1, 4C-2, and 4C-3, illustrate a scenario where, when the mobile user selects the dynamic icon on day 3, which falls on “Thanks Giving”, the mobile user is provided a recipe for cooking Turkey instead of a new word game;

FIG. 5A, which includes FIGS. 5A-1 and 5A-2, illustrates a scenario where the user settings associated with the dynamic icon is updated to reflect the current user of the mobile device and the content associated with the dynamic icon refreshed based on the user settings associated with the identified current user;

FIG. 5B, which includes FIGS. 5B-1 and 5B-2, illustrates a scenario where the mobile device determines the mobile user to be a particular user;

FIG. 6A, which includes FIGS. 6A-1 and 6A-2, illustrates customization and refreshment of the content associated with the dynamic icon in the smart phone by the content-publisher server driven by custom settings associated with the a first user;

FIG. 6B, which includes FIGS. 6B-1 and 6B-2, illustrates customization and refreshment of the content associated with the dynamic icon in the smart phone by the content-publisher server driven by custom settings associated with the a second user; and

FIG. 7 is a high-level block diagram showing an example of the architecture for a computer system.

The headings provided herein are for convenience only and do not necessarily affect the scope or meaning of the claimed invention.

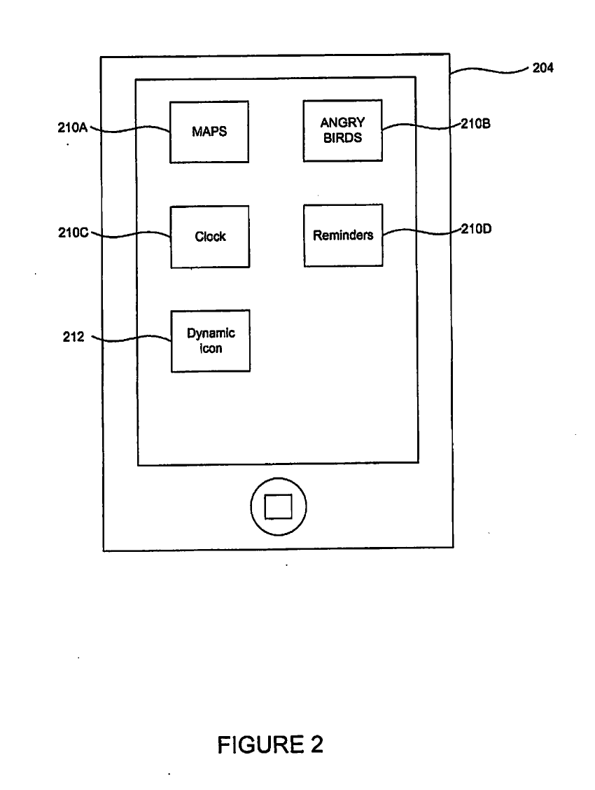

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

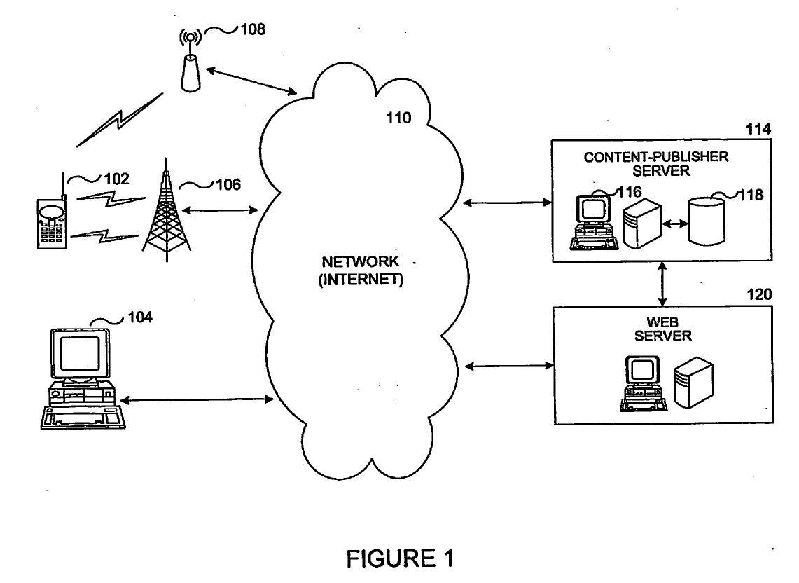

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a mobile device 102, a personal computer 104, etc.) to communicate with a network. The term “mobile device,” as used herein, may be a cell phone, a personal digital assistant (PDA), a portable email device (e.g., a Blackberry®), a portable media player (e.g., an IPod Touch®), or any other device having communication capability to connect to the network. In one example, the mobile device 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the mobile device 102 (with, for example, WiFi capability) or the personal computer 104 to access web content offered through various web servers. In some instances, especially where the mobile device 102 is used to access web content through the network 110 (e.g., when a 3G or an LTE service of the mobile device 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the mobile device 102, the personal computer 104, etc.) to connect to the content-publisher server 116 through the network 110. In one embodiment, a mobile device 102 may allow access to the content-publisher server 116 through the network 110 by using a mobile application (“app”) resident on the mobile device 102 and executable by selection of an application icon associated with the mobile application. In another embodiment, a mobile device 102 may allow the content-publisher server 116 to send content over the network 110 for the mobile device 102. The received content could be accessed by selection of a host icon associated with the received content, where the selection allows access to any received content through the mobile device 102.

In one embodiment, the content-publisher server 116 could refresh the content associated with the host icon based on a set of criteria, where the previous content could be disassociated from the host icon and the new content associated with the host icon. The host icon could thus serve as a “dynamic” icon representing a plurality of applications and communications instead of being associated with a single application or communication.

In one instance, the dynamic icon could be installed on the mobile device 102 by the user of the mobile device 102, where the mobile user could download the dynamic icon from an application store, such as iTunes app store. In another instance, the dynamic icon could be served as a free service through another mobile application that is installed in the user's mobile device 102. For example, the dynamic icon could be offered in an interstitial advertisement or a banner advertisement featured within a mobile application.

In some instances, the dynamic icon could be paired with a mobile application, where installation of the mobile application on a mobile device 102 will also install the dynamic icon on the mobile device 102. In general, mobile applications, independent of the dynamic icon, generate advertisement revenue for the publisher of mobile applications. Advertisements could be featured in a mobile application in the form of interstitial ads, full-page ads, banner ads, etc. at pre-determined time frames within the mobile application, where each publication of the advertisement could earn advertisement revenue for the mobile application publisher.

In one instance, the dynamic icon can act as an additional source of revenue generation for a publisher associated with the dynamic icon. As discussed above, the dynamic icon could communicate with the content-publisher server 116 through the network 110. In one instance, the content-publisher server 116 could be configured to send advertisements and other content to be associated with the dynamic icon, which when viewed or interacted with by the mobile user could result in advertisement revenue generation for the mobile application publisher.

For example, as described below in detail, the content-publisher server 116 could install a free mobile application in the mobile device 102 and associate the application with the dynamic icon. The publisher associated with the dynamic icon could earn $5 per mobile device 102 when a mobile user selects the dynamic icon and launches the associated free mobile application (similar to a cost-per-click model of advertisement). In another instance, the publisher associated with the dynamic icon could earn $5 per mobile device 102 only when a mobile user upgrades from the associated free mobile application to a paid version of the mobile application (similar to a conversion model of advertisement).

In another embodiment, the content-publisher server 116 is associated with a database 118, where the database 118 includes a collection of content that could be served to a mobile user. The content-publisher server 116 could query the database 118 for a content to serve a given mobile device 102, where the query could include criteria that help the database 118 to determine an appropriate content to provide the content-publisher server 116. The plurality of content stored in the database 118 could include advertisements, mobile application, daily deals, promotions, coupons, news reports, etc.

In some instances, the content-publisher server 116 and database 118 could be associated with an ad network that receives and distributes advertisements to various consumer devices and content pages of web page publishers. The ad network could provide the content-publisher server 116 and associated database 118 with advertisements that could be served as content to various mobile device 102s. In one instance, the content received from the content-publisher server 116 could be a banner advertisement. In another instance, the content received from the content-publisher server 116 could be a video advertisement. In some instances, the content received from the content-publisher server 116 could be a list of daily deals. When a mobile user selects the dynamic icon, the mobile user could be prompted with the list of daily deals received from the content-publisher server 116.

Further, in some instances, the content received from the content-publisher server 116 could be a mobile application, where the dynamic icon serves as the application icon for the received mobile application and the selection of the dynamic icon could launch the received mobile application. In some embodiments, when the content to be sent is a mobile application, the content-publisher server 116 could access the mobile device 102 through the network 110 and install the mobile application on the mobile device 102.

In some instances, when a mobile device 102 user's permission is required to install a mobile application on the mobile device 102, the content-publisher server 116 could either prompt the mobile device 102 user for permission to install the mobile application or check mobile user provided settings associated with the dynamic icon for permission to install the mobile application and associate the application with the dynamic icon.

In another instance, the content-publisher server 116 could install multiple mobile applications and associate them with the dynamic icon. In one embodiment, when multiple mobile applications are installed, the content-publisher server 116 could create a list of application icons and associate each icon with one of the installed mobile applications. The list of application icons could then be associated with the dynamic icon, where the selection of the dynamic icon could provide the mobile user with the list of associated application icons. The mobile user could select any of the application icons from the provided list to launch the associated mobile application.

In one embodiment, the content-publisher server 116 can send a given mobile device 102 content on a pre-determined interval. The pre-determined interval can be set in the dynamic icon settings associated with the dynamic icon. The pre-determined interval can be in units of time, such as one refresh of content per day, one refresh of content per hour, etc. In another embodiment, the content-publisher server 116 can send content to a mobile device 102 in response to a mobile user selecting the dynamic icon.

In another embodiment, the content-publisher server 116 could customize the content sent to the mobile user based on various general and custom criteria associated with the mobile user. In one instance, where the dynamic icon is acting as an icon ad, the content-publisher server 116 could increase the advertisement revenue for the publisher associated with the icon ad by customizing the content to include applications and information that best appeal to a given mobile user's interest. For one, the customized content could increase the mobile user's interest in the content associated with the dynamic icon, increasing the chances of the mobile user selecting the dynamic icon and launching the associated content. The viewed content could generate advertisement in the form of impressions (eCPM) and cost-per-click (CPC). Further, when the provided content appeals to the mobile user, there is an increased chance that the mobile user would subscribe to a paid version of the provided content, resulting in a conversion if the upgrade is defined as such by the advertiser.

In one embodiment, the general criteria could include special days of the year, such as Christmas, Thanks giving, etc., and time of the day, such as 6 am, 12 pm, etc. The custom criteria could include the mobile user's age, sex, skill level, hobbies, interests, etc. In embodiments, the custom criteria could either be provided by the mobile user and associated with the dynamic icon user settings or gathered by the content-publisher server 116 using a mobile application installed on the mobile user's mobile device 102. The user tracking mobile application could gather the custom criteria by monitoring the mobile user's activities on the mobile device and through monitoring the Facebook and other social media accounts of the mobile user. For example, when a mobile user has a plurality of word games installed on their mobile device 102 and utilizes them regularly, the user tracking mobile application could capture the mobile user's special interests in word games as a custom criterion. Further, the user tracking mobile application could monitor the user's social media accounts to learn about the mobile user's special interest, such as a user's interest in photography, fishing, etc., and capture the mobile user's special interests in fishing and photography as a custom criteria.

In one instance, the content could be a mobile application. The content-publisher server 116 could customize the mobile application based on the general and special criteria associated with dynamic icon. For example, when the time of the day is morning 6am, the content-publisher server 116 could serve a weather report app. When the mobile user selects the dynamic icon, the weather report app is launched, providing the mobile user with the relevant current weather conditions for the day. In another example, when the mobile user is determined to an avid word games player, the content-publisher server 116 could serve the mobile user with a new type of word game that the user does not already have installed on their mobile device 102.

In one embodiment, based on the general and custom criteria associated with the dynamic icon, the content-publisher server 116 could keep refreshing the content associated with the dynamic icon by removing the prior content and associating a new content with the dynamic icon. For example, the content-publisher server 116 could have previously served the mobile user a photo-editing app, such as Instagram, through the dynamic icon. When the user settings prompt the content-publisher server 116 to refresh the content, the content-publisher server 116 could uninstall the photo-editing app associated with the dynamic icon and install an app related to fly-fishing and associate the installed app with the dynamic icon. When the mobile user next selects the dynamic icon, the fly-fishing related app will be launched instead of the previously associated photo-editing app.

In one embodiment, when the content-publisher server 116 is refreshing the content, the content-publisher server 116 could create a new icon in the mobile device 102 and associate the previously served content with the new icon. The content-publisher server 116 could then disassociate the previously served content from the dynamic icon and serve a new content to the mobile device 102, associating the new content with the dynamic icon. The mobile user could then invoke both the previously served content and the new content using their respective associated icons.

In an alternate embodiment, the dynamic icon and the associated services could be replicated in a personal computer 104. The personal computer 104 could perform the equivalent function of the mobile device 102, allowing installation of applications, receiving content from the content-publisher server 116 and providing the personal computer's user access to the received content. The content-publisher server 116 and other associated elements could function with the personal computer 104 in a similar manner.

For purpose of further illustration, it is useful to consider the techniques explained herein as it applies to content offered in a mobile device. Of course, however, it should be noted that the techniques introduced here extend to other types of situations where the content is offered for other computational platforms.

An illustration of the above example of using various general and custom criteria to customize the content served to a given mobile user through the dynamic icon is discussed in relation to FIGS. 2 through 6.

FIG. 2 illustrates a smart phone 204 with various applications and their associated icons 210A, 210B, 210C, 210D and 212 respectively. The smart phone includes the dynamic icon 212, where selecting the dynamic icon 212 would provide the mobile user access to the associated content.

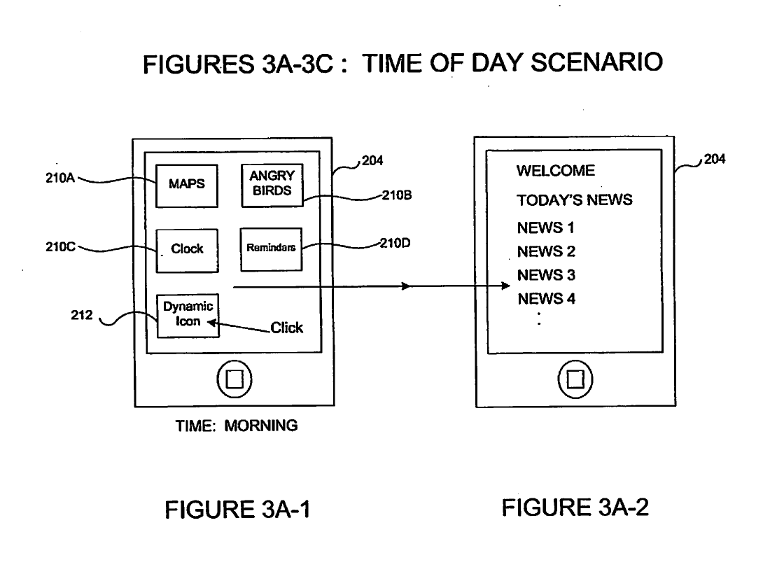

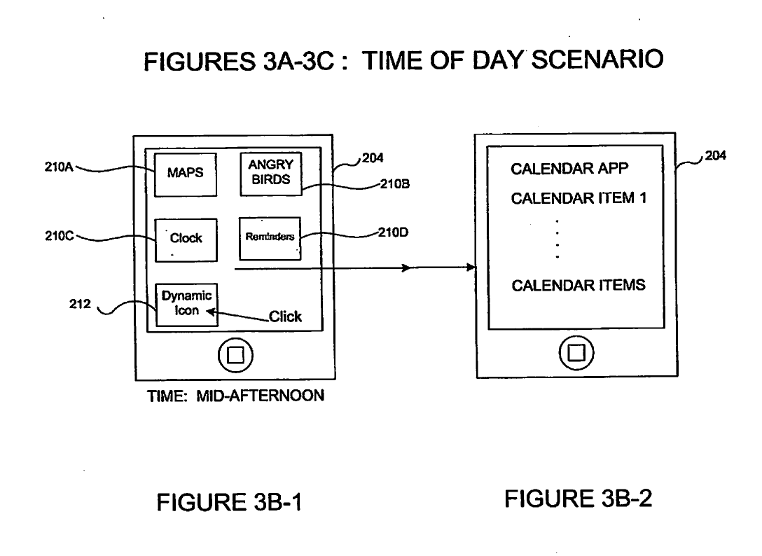

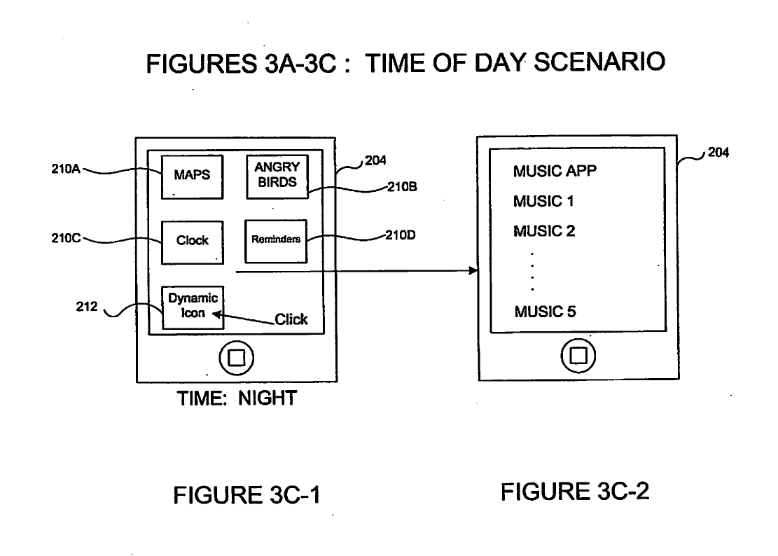

FIGS. 3A, 3B and 3C illustrate customization and refreshment of the content associated with the dynamic icon 212 in the smart phone 204 by the content-publisher server 116 based on the general user settings of “Time of day”. FIGS. 3A-1 and 3A-2 illustrate a scenario where, when the time of the day is characterized as “morning”, the content-publisher server 116 provides the mobile user with news reports through the dynamic icon 212. FIGS. 3B-1 and 3B-2 illustrate a scenario where, when the time of the day is characterized as “mid-afternoon”, the content-publisher server 116 provides the mobile user with calendar items through the dynamic icon 212. A mobile user would find a quick review of calendar items during mid-day more relevant than news reports during mid-day. FIGS. 3C-1 and 3C-2 illustrate a scenario where, when the time of the day is characterized as “night”, the content-publisher server 116 provides the mobile user with a streaming music app through the dynamic icon 212. A mobile user would prefer to listen to music and go to sleep than review calendar items.

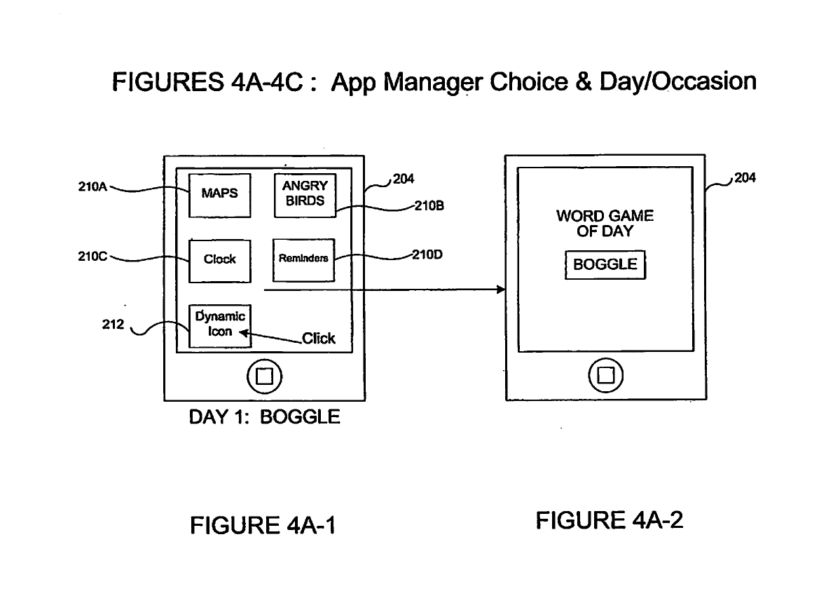

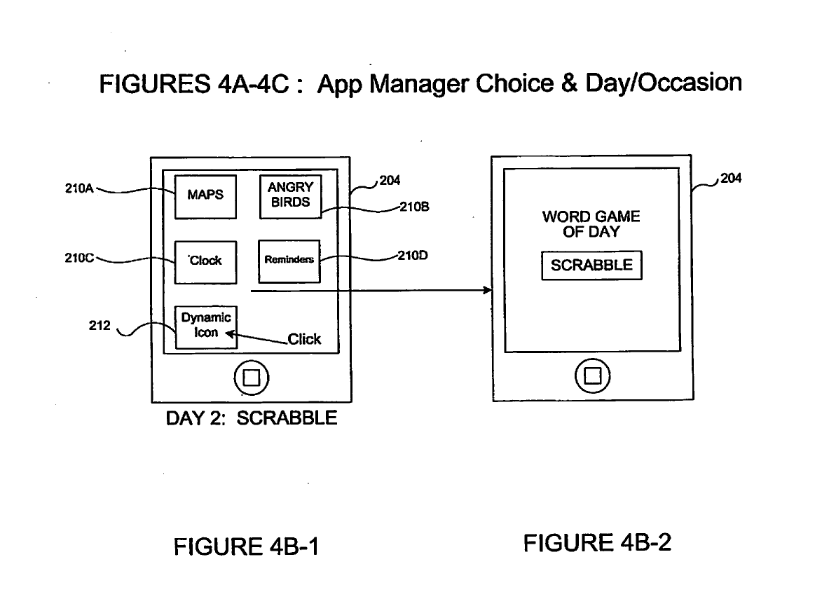

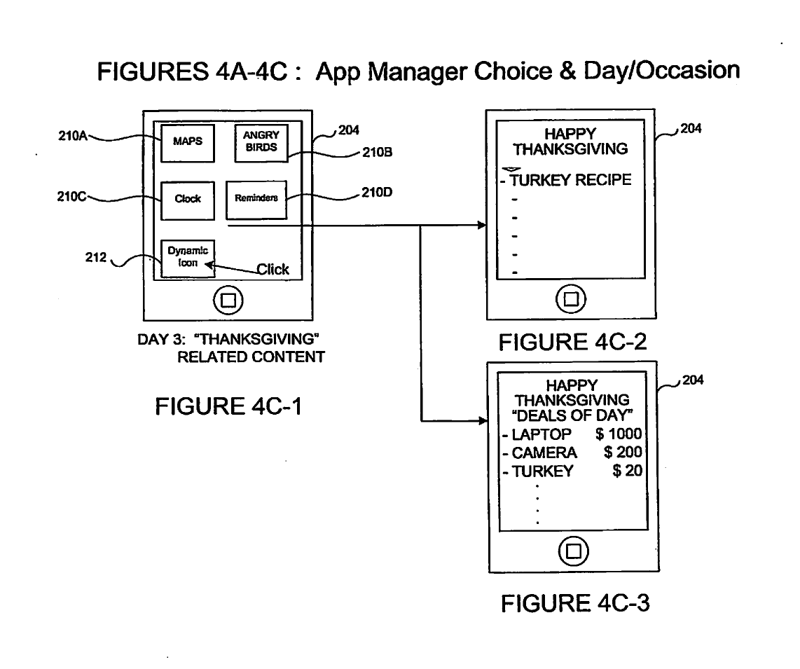

FIGS. 4A, 4B and 4C illustrate customization and refreshment of the content associated with the dynamic icon 212 in the smart phone 204 by the publisher associated with the dynamic icon and general user settings of “Special Occasion days”. FIGS. 4A-1 and 4A-2 illustrate a scenario where, when the publisher associated with the dynamic icon is determining the content and the publisher specializes in providing word games, the mobile user could be served with various games at a refresh rate determined by either the mobile user or the publisher. Here, the mobile user is provided a word game called “Boggle” on day 1 through the dynamic icon 212. FIGS. 4B-1 and 4B-2 illustrate a scenario where, when the mobile user selects the dynamic icon 212 on day 2, the mobile user is provided a new word game called “Scrabble” instead of the previous word game “Boggle”. The word game “Boggle” is disassociated from the dynamic icon 212 on day 2 and the word game “Scrabble” is associated with the dynamic icon 212. FIGS. 4C-1, 4C-2, and 4C-3 illustrate a scenario where, when the mobile user selects the dynamic icon 212 on day 3, which falls on “Thanks Giving”, the mobile user is provided a recipe for cooking Turkey instead of a new word game. The content-publisher server 116 could further refresh the content associated with the dynamic icon 212 based on the time of the day settings to provide the user with a list of shopping deals available during the Thanks Giving weekend.

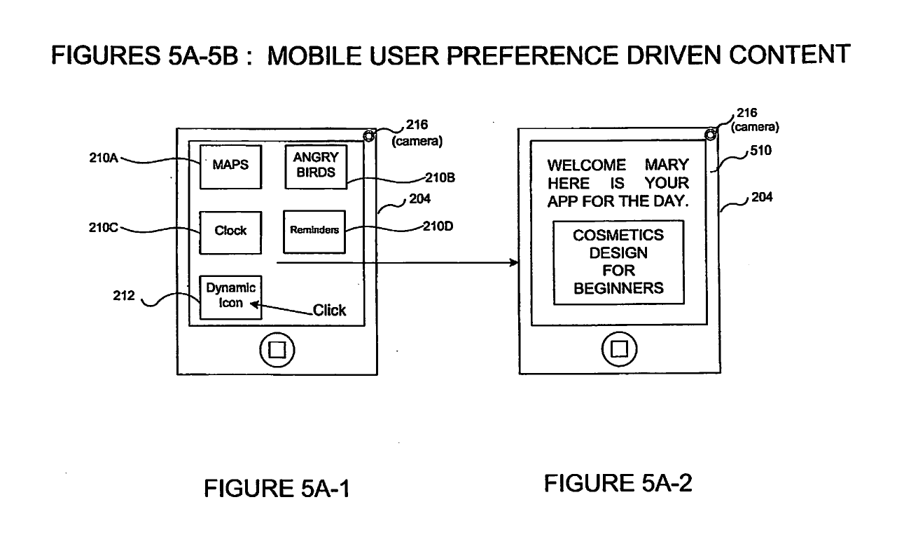

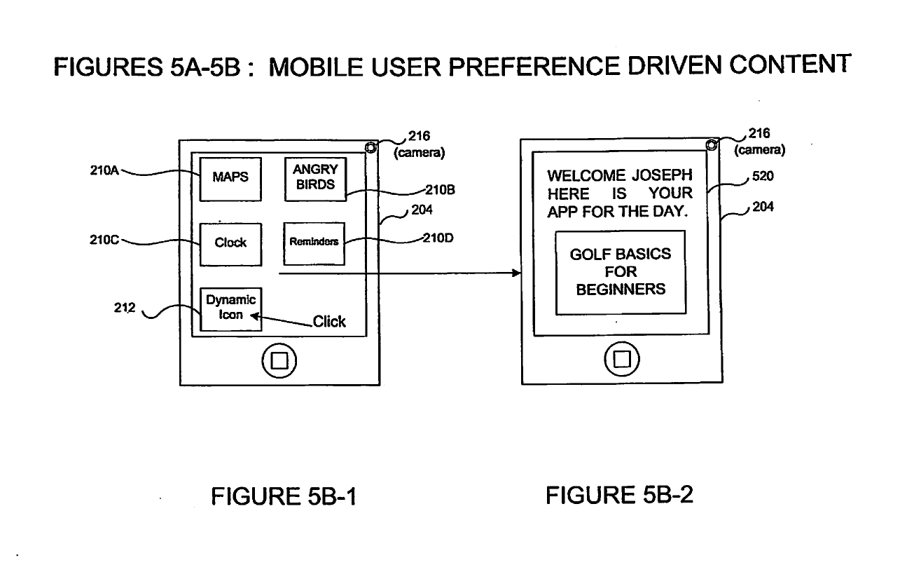

FIGS. 5A and 5B illustrate customization and refreshment of the content associated with the dynamic icon 212 in the smart phone 204 by the content-publisher server 116 driven by custom settings associated with the user. FIGS. 5A and 5B illustrate a scenario where a given mobile device is used by multiple users and the content associated with the dynamic icon 212 is refreshed based by the content-publisher server 116 based on the identity of the mobile user. FIG. 5A-1 and 5A-2 illustrate a scenario where the user settings associated with the dynamic icon 212 is updated to reflect the current user of the mobile device and the content associated with the dynamic icon 212 refreshed based on the user settings associated with the identified current user. The mobile camera 216 embedded on the mobile device 204 could be utilized by the dynamic icon 212 to identify the current user of the mobile device 204 and update the user and user settings to reflect the current user. In the illustration 5A-1 and 5A-2, Mary is determined to the current user of the mobile device. The user will be updated to Mary and the user settings of the dynamic icon 212 will be updated to those of Mary's. The content-publisher server 116 could then refresh the content associated with the dynamic icon 212 based on Mary's preferences and hobbies, which in this instance is served an app related to cosmetic design, one of Mary's hobbies. FIG. 5B-1 and 5B-2 illustrate a scenario where the mobile device determines the mobile user to be Joseph. Again, the mobile device updates the user to Joseph and the dynamic icon 212 settings to those of Joseph's. The content-publisher server 116 could then refresh the content associated with the dynamic icon 212 based on Joseph's preferences and hobbies, which in this instance is served an app related to golf, one of Joseph's hobbies.

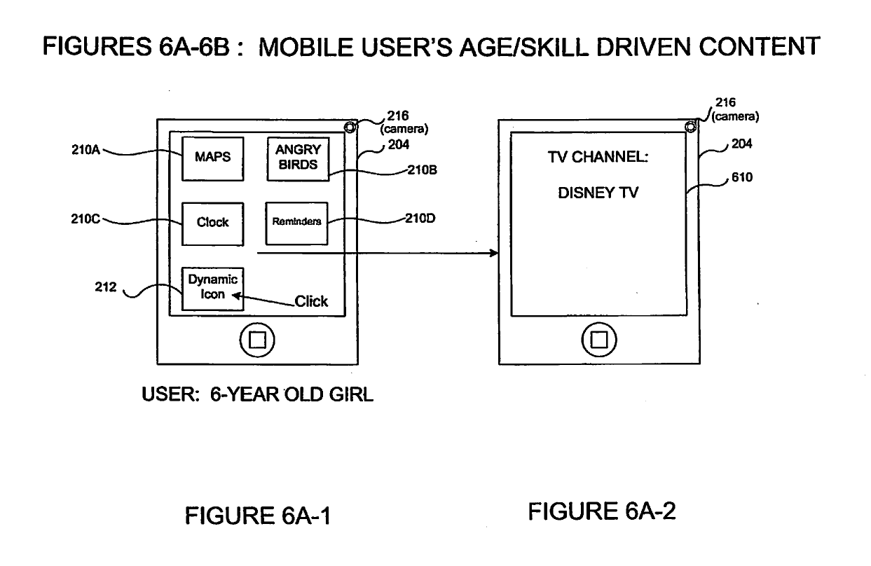

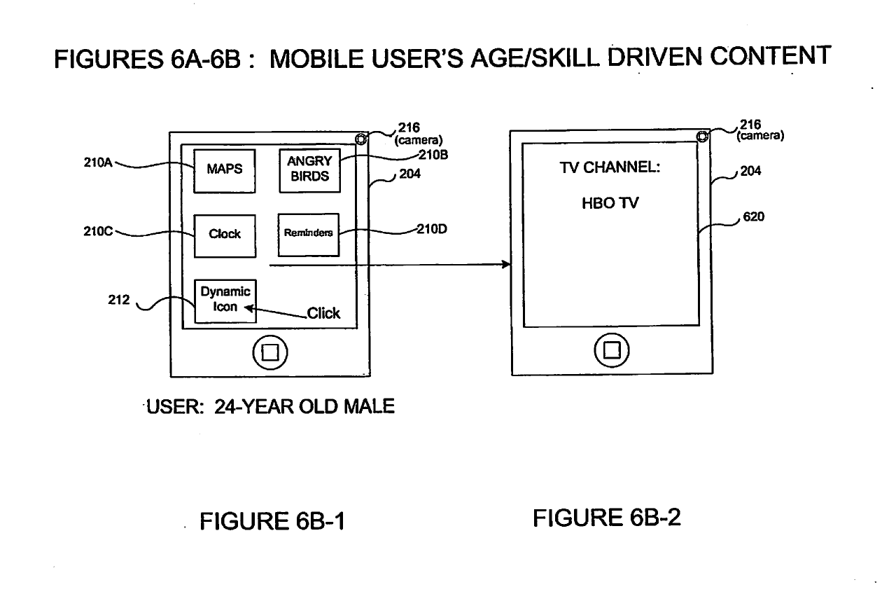

FIGS. 6A and 6B illustrate customization and refreshment of the content associated with the dynamic icon 212 in the smart phone 204 by the content-publisher server 116 driven by custom settings associated with the user. Here, the custom settings are determined by the mobile device 204 instead of being provided by the mobile user. FIGS. 6A and 6B illustrate a scenario where a given mobile device is used by multiple users and the content associated with the dynamic icon 212 is refreshed based by the content-publisher server 116 based on the identity of the mobile user and the user's associated settings as determined by the mobile device 204. As illustrated in FIGS. 5A and 5B, the mobile device 204 could utilize the camera 216 and determine the identity of the user. Every time a user is identified, the mobile device 204 gathers the user's interests, approximate age and skill level by monitoring the user's mobile usage. In FIGS. 6A-1 and 6A-2, the mobile device 204 determines the user to be a 6 year old girl. In this instance, the content-publisher server 116 associates a children's streaming TV channel, such as Disney, with the dynamic icon 212. In FIGS. 6B-1 and 6B-2, the mobile device 204 determines the user to have changed to a 24 year old male. In this instance, the content-publisher server 116 associates an adult streaming TV channel, such as HBO GO, with the dynamic icon 212.

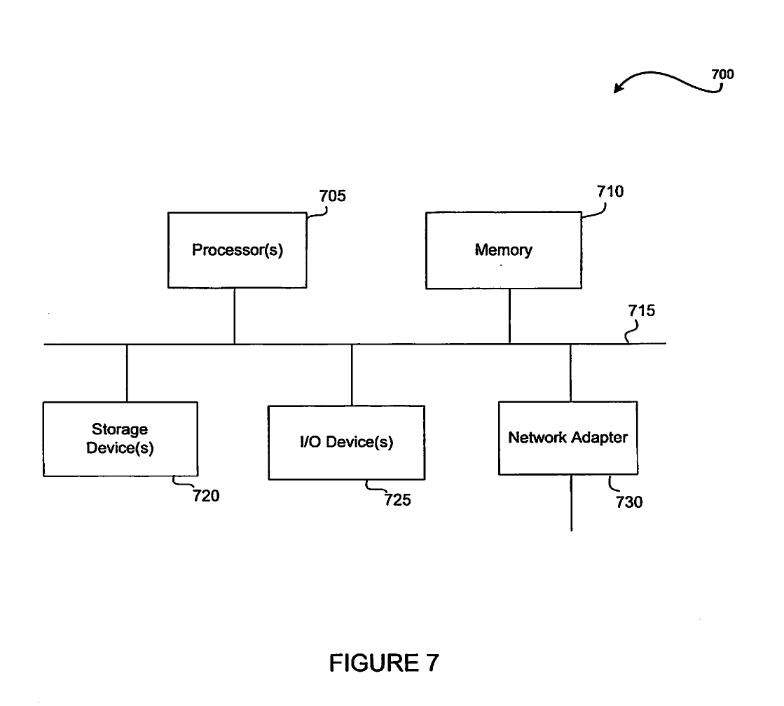

FIG. 7 is a high-level block diagram showing an example of the architecture for a computer system 700 that can be utilized to implement a content-publisher server (e.g., 114 from FIG. 1), a web server (e.g., 125 from FIG. 1), etc. In FIG. 7, the computer system 700 includes one or more processors 705 and memory 710 connected via an interconnect 725. The interconnect 725 is an abstraction that represents any one or more separate physical buses, point to point connections, or both connected by appropriate bridges, adapters, or controllers. The interconnect 725, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 794 bus, sometimes referred to as “Firewire”.

The processor(s) 705 may include central processing units (CPUs) to control the overall operation of, for example, the host computer. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 710 is or includes the main memory of the computer system 1100. The memory 710 represents any form of random access memory (RAM), read-only memory (ROM), flash memory (as discussed above), or the like, or a combination of such devices. In use, the memory 710 may contain, among other things, a set of machine instructions which, when executed by processor 705, causes the processor 705 to perform operations to implement embodiments of the present invention.

Also connected to the processor(s) 705 through the interconnect 725 is a network adapter 715. The network adapter 715 provides the computer system 700 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶7 will begin with the words “means for.”) Accordingly, the applicant reserves the right to add additional claims after filing the application to pursue such additional claim forms for other aspects of the invention.

We claim:

1. A method comprising:
receiving a request to invoke a first app in a smart device, the first app invoked by activation of a corresponding first app icon displayed at the smart device; and
selecting one of a plurality of database apps to be offered at the smart device in response to the received request, wherein the selected one of the plurality of database apps is offered as the first app in the smart device in response to the request to invoke the first app, wherein:
a particular one of the plurality of database apps is dynamically selected in response to the request based on one or more criteria associated with the selection of the one of the plurality of database apps;
and
the selected one of the plurality of database apps is offered as the first app at the smart device.

2. The method of claim 1, further comprising:
determining a time-of-the-day value associated with the received request;
selecting one of the plurality of database apps as the first app based on the determined time-of-the-day value.

3. The method of claim 2, further comprising:
prior to receiving the request, obtaining a first user's preference relating to a type of app to offer based on different time-of-the-day values;
in response to receiving the request from the first user, selecting a given one of the plurality of database apps according to the previously obtained preferences of the first user.

4. The method of claim 3, further comprising:
receiving the request from the first user at a first time-of-the-day value;
determining the given app from one of a first subplurality of apps from the plurality of database apps, the first subplurality of apps corresponding to the first user's preferences for apps to be offered for the first time-of-the-day value.

5. The method of claim 2, wherein the time-of-the-day value is one of a morning time, a mid-morning time, a noon time, an early evening time, an evening time, and a late-evening time.

6. The method of claim 1, further comprising:
determining a first user associated with the smart device;
selecting a given one of the plurality of apps as the first app based on the determined first user.

7. The method of claim 6, wherein determining the first user associated with the smart device includes:
receiving an image of the first user from the smart device; and
identifying the first user using one or more image recognition methodologies.

8. The method of claim 6, wherein determining the user associated with the smart device includes:
receiving identity information as input from the first user in conjunction with receiving the request.

9. The method of claim 6, wherein determining the user associated with the smart device includes:
identifying the first user based on a current user account used in conjunction with the received request.

10. The method of claim 6, further comprising:
prior to receiving the request, obtaining the first user's preference relating to a type of app to offer based on the user's identity;
in response to receiving the request from the first user, selecting a given one of the plurality of database apps according to the previously obtained preferences of the first user.

11. The method of claim 10, wherein obtaining the first user's preference further includes obtaining the first user's preference relating to a type of app to offer based on a time-of-day value associated with the received request.

12. The method of claim 1, wherein the one or more criteria associated with the selection of one of the plurality of database apps includes one or more of:
a time-of-the-day value;
a day-of-the-week value;
a month-of-the-year value;
a user preference value;
a user identity value;
a user age-group value; or
a random selection value.

13. The method of claim 1, further comprising:
determining a usage-level of a first user associated with the received request;
selecting one of the plurality of database apps as the first app based on the determined usage-level.

14. The method of claim 13, wherein the usage-level is one or more of:
an age-level associated with the first user;
a maturity-level associated with the first user; or
a skill-level associated with the first user.

15. The method of claim 13, wherein the plurality of database apps corresponds to a given app with a plurality of level settings, each database app corresponding to the given app with a different level setting, each level setting associated with a given skill-level required for engagement with a corresponding database app.

16. The method of claim 13, wherein the plurality of database apps corresponds to a given app with a plurality of level settings, each database app corresponding to the given app with a different level setting, each level setting associated with a given maturity-level required for engagement with a corresponding database app.

17. A method comprising:
receiving a request from a first user to invoke a first app in a smart device, the first app invoked by activation of a corresponding first app icon displayed at the smart device;
determining an identity associated with the first user;
selecting one of a plurality of database apps to be offered at the smart device in response to the received request, wherein the selected one of the plurality of database apps is offered as the first app in the smart device in response to the request to invoke the first app, wherein:
a particular one of the plurality of database apps is dynamically selected in response to the request based on one or more criteria associated with the selection of the one of the plurality of database apps;
and
the selected one of the plurality of database apps is offered as the first app at the smart device.

18. The method of claim 17, further comprising:
determining a usage-level of the first user;
selecting one of the plurality of database apps as the first app based on the determined usage-level.

19. The method of claim 18, wherein the usage-level is one or more of:
an age-level associated with the first user;
a maturity-level associated with the first user; or
a skill-level associated with the first user.

20. The method of claim 17, wherein determining the identity of the first user includes:
receiving an image of the first user from the smart device; and
identifying the first user using one or more image recognition methodologies.

21. The method of claim 17, wherein determining the identity of the first user includes:
receiving identity information as input from the first user in conjunction with receiving the request.

22. The method of claim 17, wherein determining the identity of the first user includes:
identifying the first user based on a current user account used in conjunction with the received request.

23. The method of claim 17, further comprising:
prior to receiving the request, obtaining the first user's preference relating to a type of app to offer based on the user's identity;
in response to receiving the request from the first user, selecting a given one of the plurality of database apps according to the previously obtained preferences of the first user.

24. The method of claim 17, wherein obtaining the first user's preference further includes obtaining the first user's preference relating to a type of app to offer based on a time-of-day value associated with the received request.

25. A system comprising:
a processor;
a memory configured to store a set of instructions, which when executed by the processor cause the system to perform a method, the method including:
receiving a request to invoke a first app in a smart device, the first app invoked by activation of a corresponding first app icon displayed at the smart device; and
selecting one of a plurality of database apps to be offered at the smart device in response to the received request, wherein the selected one of the plurality of database apps is offered as the first app in the smart device in response to the request to invoke the first app, wherein:
a particular one of the plurality of database apps is dynamically selected in response to the request based on one or more criteria associated with the selection of the one of the plurality of database apps; and
the selected one of the plurality of database apps is offered as the first app at the smart device.

26. The system of claim 25, wherein the method further comprises:
determining a time-of-the-day value associated with the received request;
selecting one of the plurality of database apps as the first app based on the determined time-of-the-day value.

27. The system of claim 26, wherein the method further comprises:
prior to receiving the request, obtaining the first user's preference relating to a type of app to offer based on different time-of-the-day values;
in response to receiving the request from the first user, selecting a given one of the plurality of database apps according to the previously obtained preferences of the first user.

28. The system of claim 27, wherein the method further comprises:
receiving the request from the first user at a first time-of-the-day value;
determining the given app from one of a first subplurality of apps from the plurality of database apps, the first subplurality of apps corresponding to the first user's preferences for apps to be offered for the first time-of-the-day value.

29. The system of claim 25, wherein determining the first user associated with the smart device includes:
receiving an image of the first user from the smart device; and
identifying the first user using one or more image recognition methodologies.

30. The system of claim 25, wherein determining the user associated with the smart device includes:
receiving identity information as input from the first user in conjunction with receiving the request.

31. The system of claim 25, wherein the method further comprises:
prior to receiving the request, obtaining the first user's preference relating to a type of app to offer based on the user's identity;
in response to receiving the request from the first user, selecting a given one of the plurality of database apps according to the previously obtained preferences of the first user.

32. A system comprising:
a processor;
a memory configured to store a set of instructions, which when executed by the processor cause the system to perform a method, the method including:
receiving a request from a first user to invoke a first app in a smart device, the first app invoked by activation of a corresponding first app icon displayed at the smart device;
determining an identity associated with the first user;
selecting one of a plurality of database apps to be offered at the smart device in response to the received request, wherein the selected one of the plurality of database apps is offered as the first app in the smart device in response to the request to invoke the first app, wherein:
a particular one of the plurality of database apps is dynamically selected in response to the request based on one or more criteria associated with the selection of the one of the plurality of database apps; and
the selected one of the plurality of database apps is offered as the first app at the smart device.

33. The system of claim 32, wherein the method further comprises:
determining a usage-level of the first user;
selecting one of the plurality of database apps as the first app based on the determined usage-level.

34. The system of claim 33, wherein the usage-level is one or more of:
an age-level associated with the first user;
a maturity-level associated with the first user; or
a skill-level associated with the first user.

35. The system of claim 32, wherein determining the identity of the first user includes:
receiving an image of the first user from the smart device; and
identifying the first user using one or more image recognition methodologies.

36. The system of claim 32, wherein determining the identity of the first user includes:
receiving identity information as input from the first user in conjunction with receiving the request.

37. The system of claim 32, wherein determining the identity of the first user includes:
identifying the first user based on a current user account used in conjunction with the received request.
